(19) United States
(12) Patent Application Publication
(10) Pub. No.: US 2021/0256837 A1
(43) Pub. Date: Aug. 19, 2021

(54) FUEL TANK MONITORING SYSTEMS AND METHODS

(71) Applicant: Dominick J. DeQuarto, Odessa, FL (US)

(72) Inventor: Dominick J. DeQuarto, Odessa, FL (US)

(21) Appl. No.: 17/177,074

(22) Filed: Feb. 16, 2021

Related U.S. Application Data
(60) Provisional application No. 62/975,863, filed on Feb. 13, 2020.

(51) Int. Cl. G08C 17/02; G01F 23/00

(52) U.S. Cl. CPC G08C 17/02; G01F 23/0069

(57) ABSTRACT

A system for monitoring fuel level in a fuel tank including a wireless tank sensor unit and wireless receiver unit pairing. The wireless tank sensor unit is mountable to a fuel tank and interacts with the installed fuel level gauge assembly and operates to transmit fuel level data to the wireless receiver unit installable in a remote location in radio frequency (RF) range of the wireless tank sensor unit. The wireless receiver unit operates to process the received fuel level data and provide, responsive to fuel level data exceeding user-defined thresholds, notifications corresponding to actions to be taken corresponding to a refill event. In some embodiments, the system may further include a mobile application installable on a portable electronic device. The system may operate in an internet-connected mode or an internet-disconnected mode based on user preference and/or availability of an internet connection.

### CROSS REFERENCE AND INCORPORATION BY REFERENCE

This application claims the benefit of priority of U.S. Provisional Application No. 62/975,863 filed Feb. 13, 2020, the disclosure of which is incorporated by reference herein in its entirety.

### TECHNICAL FIELD

The subject matter disclosed herein relates generally to condition monitoring systems and methods, and more particularly, to a wireless tank sensor unit and wireless receiver unit pairing operable for remotely monitoring a liquid level in a tank, for instance, a fuel level in a propane tank.

### BACKGROUND OF THE INVENTION

Propane is a commonly known form of liquified petroleum (LP) gas used as fuel in residential and commercial applications. Propane is typically stored as a liquid in a pressurized steel tank. Tank sizes can range from 5 gallons to in excess of 500 gallons. Small tanks that typically hold up to about 25 gallons are portable and are exchanged when empty. Tanks that hold more than about 25 gallons are typically refilled on-site. Tanks that require on-site refilling can be installed above or below ground and can be oriented vertically or horizontally.

Service is disrupted when an LP gas tank is empty. As such, devices exist for monitoring fuel levels to avoid service disruptions. For example, small tanks can be hung from a tank scale and medium and large tanks can be equipped with a liquid level gauge. While the former must be checked manually at the tank site, the latter is often monitored remotely by a third-party service provider responsible for fuel level management and refilling.

Certain consumers may desire to maintain privacy and responsibility for their household consumptions. Accordingly, what is needed are systems and methods that provide a consumer with remote capabilities to monitor system conditions, such as their system status, fuel usage, and refill requests without the involvement of a third-party monitoring service and associated costs.

### BRIEF SUMMARY OF THE INVENTION

In a first aspect, the present disclosure provides a system for monitoring fuel level in a fuel tank, the system including a wireless tank sensor unit operable for transmitting fuel level data obtained via a coupling with a fuel level gauge assembly installed on the fuel tank, the wireless tank sensor unit including a radio frequency (RF) transmitter and antenna pairing and a power supply, and a wireless receiver unit positionable in a location remote from the wireless tank sensor unit and in RF range thereof, the wireless receiver unit including an RF receiver and antenna pairing, a Liquid Crystal Display (LCD), and a processor coupled to a storage medium having encoded thereon executable instructions. The instructions, when executed by the processor, cause the processor to receive, via the RF receiver and antenna pairing, fuel level data transmitted by the wireless tank sensor unit via the RF transmitter and antenna pairing, and confirm receipt thereof by sending an acknowledgment back to the wireless tank sensor unit, cause the LCD to display the received fuel level data as a percentage of fuel remaining, process the received fuel level data by comparing the received fuel level data against at least one stored user-defined notification threshold and, responsive to the received fuel level data exceeding the at least one stored user-defined notification threshold, causing the LCD to display a notification indicating an action to be taken corresponding to a refill event, and determine, after each transmission of the fuel level data, a received signal strength.

In some embodiments, the wireless tank sensor unit may be further operable to transmit battery level data related to the power supply, and wherein the processor may be further configured to receive, via the RF receiver and antenna pairing, battery level data transmitted by the wireless tank sensor unit and cause the LCD to display battery level data as a percentage of battery life remaining.

In some embodiments, the system may further include a mobile application installable on a portable electronic device, wherein the wireless receiver unit may be configured to communicate to the mobile application, via a wireless internet connection, the fuel level data as the percentage of fuel remaining and the notification indicating the action to be taken corresponding to the refill event.

In some embodiments, at least one stored user-defined notification threshold may correspond to a percentage of fuel remaining.

In some embodiments, the wireless tank sensor unit may include a weather-proof enclosure containing the RF transmitter and the power supply and to which the antenna is externally attached and a wire for coupling with the fuel level gauge assembly, and a power switch.

In some embodiments, the wireless receiver unit may include a wall-mountable enclosure containing the RF receiver and antenna pairing and supporting the LCD, and a power supply cable connectable to a power supply.

In some embodiments, the processor may be further configured to cause the LCD to display the determined received signal strength.

In some embodiments, the system may operate in an internet-connected mode or an internet disconnected mode.

In some embodiments, the wireless tank sensor unit may be operable to transmit the fuel level data according to a configurable time interval.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and in which some features may be exaggerated, and some features may be omitted or may be represented schematically in the interest of clarity. Like reference numbers in the drawings may represent and refer to the same or similar element, feature, or function. In the drawings:

FIG. 1 is a schematic diagram of a remote monitoring system according to the present disclosure;

FIG. 2 is a block diagram of a wireless tank sensor unit architecture according to the present disclosure;

FIG. 3 is a perspective view of a wireless tank sensor unit according to the present disclosure;

FIG. 4 is a block diagram of a wireless receiver unit architecture according to the present disclosure;

FIG. 5 is a front view of a wireless receiver unit according to the present disclosure;

FIGS. 6A-6B are block diagrams of wireless receiver unit functionality according to the present disclosure;

FIGS. 7A-7C are system application screens showing a main page, advanced configuration page, and a notification configuration page, respectively; and

FIGS. 8A-8C are schematic diagrams showing tank orientation and ground location, and respective wireless tank sensor unit positioning.

### DETAILED DESCRIPTION OF THE INVENTIVE ASPECTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities. The aspects, features, and functions described below in connection with one embodiment are intended to be applicable to the other embodiments described below except where expressly stated or where any aspect, feature, or function is incompatible with an embodiment.

Operational and equipment solutions are disclosed herein for the efficient and effective remote monitoring of tank fuel level, system performance, environmental conditions, etc. The systems disclosed herein obviate the need for third-party software, base systems, and involvement in monitoring fuel levels, consumption, and usage habits. The systems further provide an information and notification environment for managing system performance, fuel levels, consumption, and refill requests privately without the need for third-party involvement and/or monitoring and associated costs. The systems and methods disclosed herein further provide ready-to-use tank monitoring solutions including a dedicated device set and ability/option to connect with a secondary device such as a smartphone or computer for advanced reporting and notification features, among other features and functionalities.

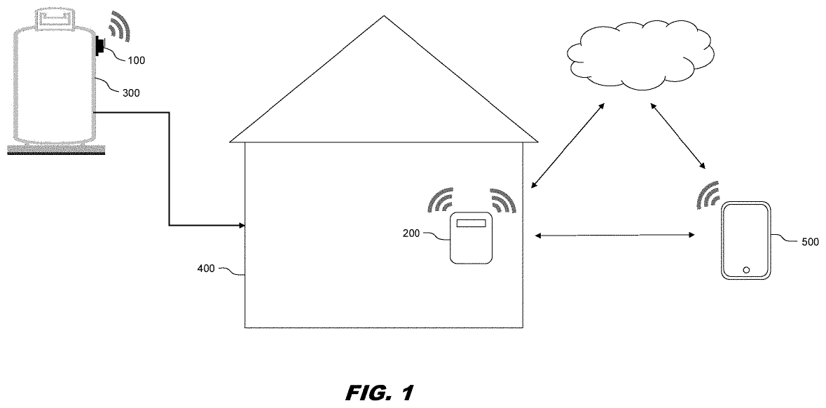

With reference to FIG. 1, a remote monitoring system according to the present disclosure generally includes a wireless tank sensor unit 100 and a programmable wireless receiver unit 200 pair. The wireless tank sensor unit 100 is configured to be mounted to a fuel tank 300, or collocated with the fuel tank, for instance, an LP fuel tank containing LP fuel. The wireless receiver unit 200 is configured to be installed in a location remote from the wireless tank sensor unit 100, for instance, mounted to a wall in a home 400 served by the LP fuel tank 300. The wireless tank sensor unit 100 is generally configured to interact with a liquid level gauge assembly installed on the tank in order to determine fluid level in the tank such that related fluid level data is transmitted to the wireless receiver unit 200. The wireless receiver unit 200 is generally configured to receive the transmitted data and process the data to generate notifications according to a customizable notification environment. In some embodiments, the wireless receiver unit 200 is configured to communicate with a secondary device, for instance, a smartphone 500 for advanced reporting and notification, among other functionality.

In some embodiments, the wireless tank sensor unit 100 is further configured to transmit data related to the signal strength and battery level of the unit. In some embodiments, environmental conditions such as ambient air temperature at the unit location may be displayed via integrated wireless tank sensor unit functionality, or alternatively, retrieved via the wireless receiver unit 200 via WIFI-internet access using an internet service provider reported geolocation for the residential location. For example, the zip code location of the residence can be input into an advanced configurations settings page. Other conditions may also be monitored. The wireless tank sensor unit 100 and the wireless receiver unit 200 communicate securely such that data transmitted by one unit is received by the other unit, and vice versa.

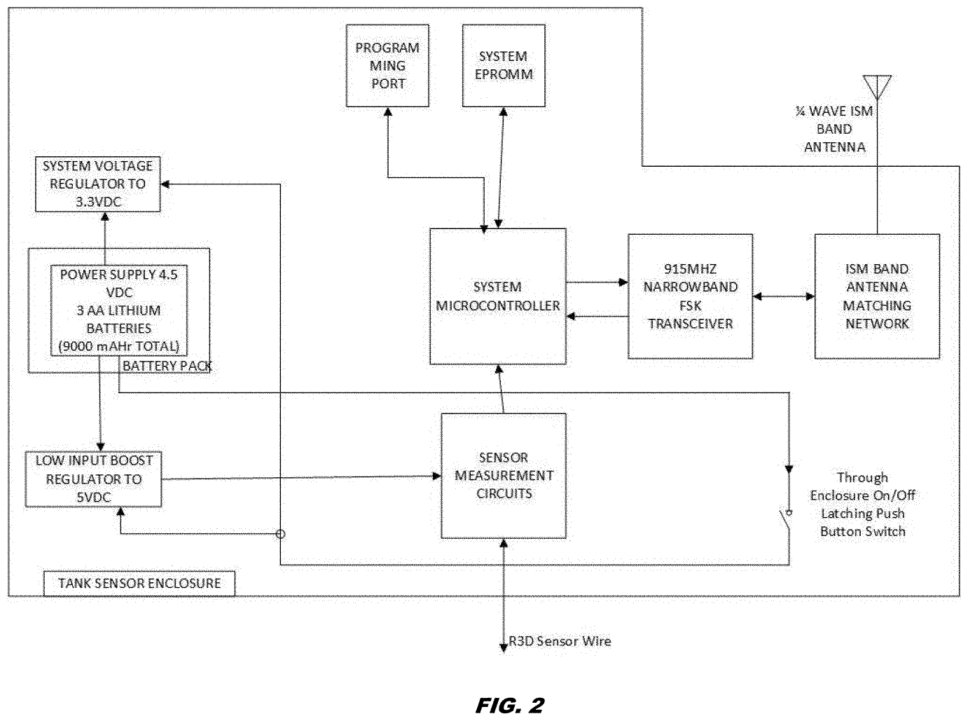

With reference to FIG. 2, the wireless tank sensor unit 100 may be battery-powered, for instance, using one or more AA batteries. The batteries may be enclosed in a battery housing enclosed within a weather-proof tank sensor enclosure. The battery housing may consolidate the batteries in series providing, for example, 4.5 VDC to tank sensor unit circuitry. The batteries may supply power to a tank sensor system voltage regulator (e.g., 3.3 VDC). Current to the tank level sensor cable may be limited to less than 200 mADC. The wireless tank sensor unit 100 may include an Atmega™ 328P-A 8-bit 16 MHZ AVR RISC-based microcontroller integrated circuit (IC) for all control, measurement and communication functions. The unit may include an internal 32 KB FLASH. The internal Atmega™ 328P-A analog inputs may be used for tank level and battery voltage measurements. The internal Atmega™ 328P-A SPI busses may be used to communicate with an RFM69 transceiver. General-purpose analog and digital I/O may be used for control and communication.

The wireless tank sensor unit may include an RF transceiver IC for short-range communication over a carrier frequency of 915 MHz and using narrowband frequency shift keying (FSK) modulation to send data packets. A compact SMT RF transceiver circuitry layout may be used to assure clean performance. An ISM band transceiver may use an external 50-ohm quarter-wave monopole antenna which screws onto the system PCB over the IP65 enclosure. The wireless tank sensor unit PCB provides an RF ground plane perpendicular to the antenna. Data transmissions may be 9600 bps and about 004 ms in duration. The RF transceiver may be powered down when not in use. The wireless tank sensor unit may include a W25X40CL Winbond™ NOR Flash serial EEPROM IC for storage of system configuration information. The EEPROM may be read at power on and may be written to after every report and after every configuration change. The EEPROM IC may hold information such as pairing and configuration information with the wireless receiver unit.

In some embodiments, the wireless tank sensor unit 100 may communicate with a Hall-Effect sensor to track the rotational position of a magnet in a dial mounted to a liquid level gauge head assembly. The sensor may be mounted at the end of an electrically coupling (e.g., cable) that may be provided as, for example, a sensor connected to a transmitter by a 22 AWG, 3-conductor, PVC jacketed cable. A non-limiting configuration may include a right-angle sensor and about a 6′ long sensor cable, while another configuration may include a straight sensor and about a 6′ long sensor cable, with both configurations traversing through an IP67 rated bulkhead grommet (connecting the sensor cable to the circuitry enclosed inside the tank sensor unit 100) on one end, and a Hall-Effect sensor on the other end. Voltage to the sensor may be regulated to 5.0 VDC and current may be limited to less than 200 mADC. The Hall-Effect sensor may be powered on for 500 ms prior to every fuel level reading in order to provide stable readings.

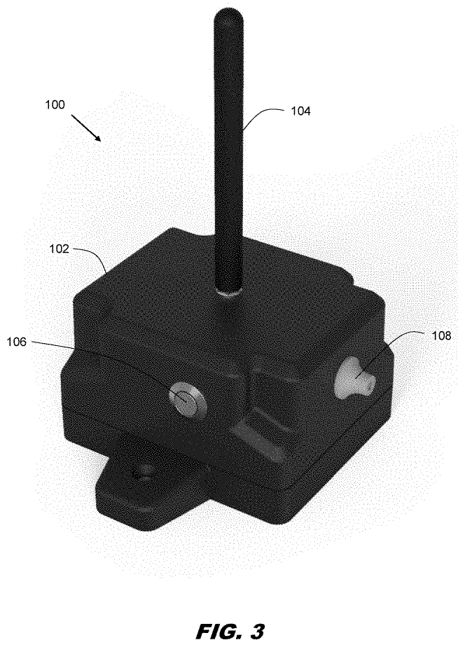

With reference to FIG. 3, the wireless tank sensor unit 100 may include a weather-proof enclosure 102 molded from UV stabilized acrylonitrile butadiene styrene (ABS) material. The enclosure 102 may be fabricated in two pieces with a weather-sealed interface such that when two enclosure halves are tightened together an IP65 rated seal is formed. Intrinsic safety and RF compatibility information may be printed on enclosure labeling. The enclosure 102 may be mounted to the fuel tank using two circular weather-resistant non-sparking counter-sunk magnets with countersunk through-center holes rated at 9.56 lbs of pull force each, for example, or may optionally be mounted using two stainless steel pan head bolts and washers applied through the center of the magnets and into/through the non-metallic mounting surface. The enclosure 102 may have multiple watertight egress/ingress holes, with one 5mm hole located at the top-center of the enclosure through which the PCB gold plated weather-resistant threaded sub-miniature A connector (SMA) antenna connector 104 protrudes, a second hole (e.g., 12 mm) located 90 degrees from the bulkhead grommet hole for the IP67 rated latching power switch 106, and a third hole on the side of the enclosure (e.g., 90 degrees from SMA) through which the sensor wire bulkhead contact watertight connector 108 protrudes.

The wireless tank sensor unit 100 may be powered on when the push-button latching switch 106 located on the outside of the tank sensor enclosure 100 is depressed. A system microcontroller clocks: 16.00 MHz internal oscillator (Off in low power mode) 32.768 kHz external crystal oscillator. (On continuously for purposes of keeping track of transmission cycles.) 915 MHz ISM Band FSK Transceiver Clock: 32.00 MHz external crystal oscillator. (Only on when ISM radio is powered up.) A system voltage regulator steps down the battery voltage of 4.5 VDC to 3.3 VDC for the system. A low input boost regulator steps up battery voltage of 4.5 VDC to 5.0 VDC to provide the Hall-Effect sensor with an even voltage source for reliable measurements (e.g., off in low power mode). The programming port may be a UART serial port. The system EEPROM contains configuration and state-full information.

When powered on, the wireless tank sensor unit 100 may remain in a state of low power sleep mode with an internal clock running. Once activated, per a customer-defined transmission cycle, the wireless tank sensor unit 102 may wake and measure the fuel level and internal battery voltage. Following these measurements, the wireless tank sensor unit 100 may wake the RF module and transmit the fluid level data, among other data, digitally via an FSK data session addressed to the wireless receiver unit which remains in a constant listening state. Communication between the wireless tank sensor unit 100 and the wireless receiver unit 200 may originate from the wireless tank sensor unit 100; however, once the wireless tank sensor unit 100 completes transmission of its data, the wireless tank sensor unit 100 may listen for an acknowledgment and possible configuration update to be sent from the wireless receiver unit 200. Confirmations may be sent, after which receipt triggers a return to low power sleep mode.

In some embodiments, an ISM band radio transceiver may be used for communicating with the wireless receiver unit. The wireless tank sensor unit 100 may include an RF 915 MHz ISM band radio transceiver for sending and receiving data packets at 9600 bps to the wireless receiver unit using a 16-byte AES encryption key with a max transmission power of +20 dBm (100 mW). The wireless tank sensor unit 100 may send ISM data packets when the transmission cycle time has elapsed, the data packets including a tank sensor transmitter packet including a 16-bit preamble, 16-byte payload (battery health and tank fuel level), and an acknowledgment.

In some embodiments, the wireless tank sensor unit 100 may operate in two basic modes depending on the state of the sensor wire female connection to the enclosure male connector. An ‘OFF’ mode may correspond to the latching power switch not being in a depressed state. An ‘ON’ mode may correspond to the latching power switch being in a depressed state. For a first-time power on, the wireless tank sensor unit 100 may wait in a receive mode listening for the wireless receiver unit to announce its presence to the wireless tank sensor unit 100 over the RF. Both units may negotiate encrypted addresses for each other used for all future secure communication and complete the pairing mode. The wireless receiver unit may send a default configuration to the wireless tank sensor unit 100 to apply an update. The wireless tank sensor unit 100 may wake when a transmission cycle has elapsed (e.g., set according to user-defined settings, e.g., 15 min, 30 min, 45 min, 1 hr, 4 hrs, 6 hrs, 8 hrs, 12 hrs, 24 hrs, etc.). During wake-up, the wireless tank sensor unit 100 may sense fuel level and measure battery life. The wireless tank sensor unit 100 may then transmit the related data to the wireless receiver unit and wait for acknowledgment, and upon receipt of an acknowledgement, enter a sleep mode until the next transmission cycle elapses.

With reference to FIG. 4, the wireless receiver unit 200 may be powered using a standard USB “Type A” 5.0 VDC wall power supply regulated down to 3.3 VDC for the circuitry. The power supply may need only provide a max current of 500 mA. The wireless receiver unit 200 may include an AI Thinker ESP8266 which integrates an ultra-low-power 32-bit MCU micro, with the 16-bit short mode, clock speeds that support 80 MHz and 160 MHz, integrated WIFI MAC/BB/RF/PA/LNA, and an onboard antenna. The module may support standard IEEE802.11 b/g/n agreement, complete TCP/IP protocol stack.

The wireless receiver unit 200 may include an RF transceiver IC for short-range communication which communicates with the onboard MCU via GPIO pins. The transceiver may operate at a carrier frequency of 915 MHz and use narrowband FSK modulation to send data packets. Compact SMT RF transceiver circuitry layout assures clean performance. An ISM band transceiver may use an internal Yageo™ Omni-directional chip antenna soldered to the system PCB. The wireless receiver unit system PCB provides an RF ground plane that is parallel to the antenna. Data transmissions may be at 9600 bps and about 004 ms in duration. The RF transceiver may be set to constantly powered on, and when not transmitting data, set to listening mode.

The wireless receiver unit 200 can include an onboard integrated 4 MB SPI Flash (included in ESP8266 architecture) for storage of firmware and integrated SRAM for system configuration information. The SRAM can be read at power on and is written to after every report, and after every configuration change. The SRAM IC holds information such as pairing and configuration information with the wireless tank sensor unit. The wireless receiver unit may include a PCF8574 remote 8-Bit I/O expander for the I2C connector supporting the onboard 16×2 liquid crystal display (LCD).

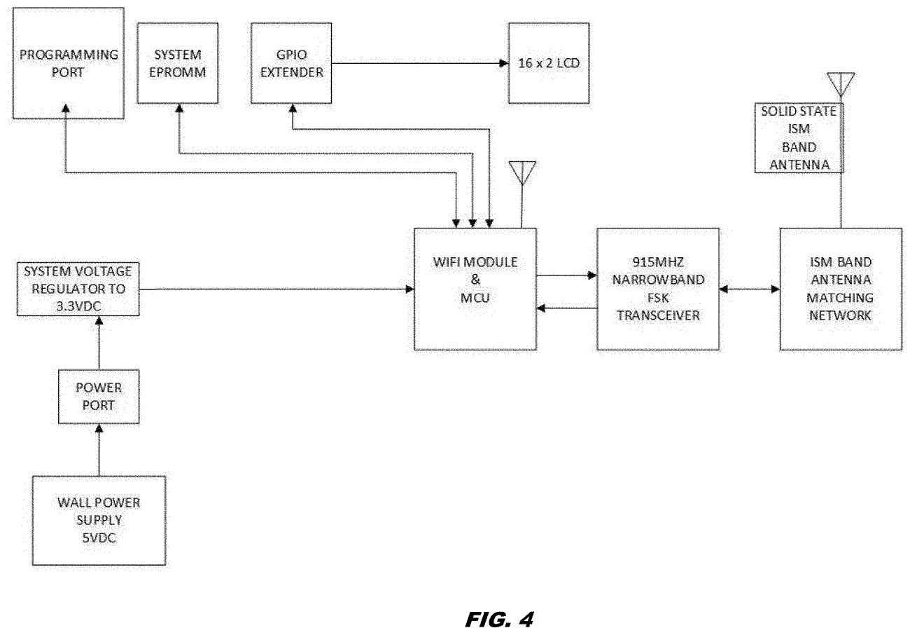

With reference to FIG. 5, the wireless receiver unit 200 can be implemented as a wall-mountable unit generally including a molded enclosure 202 constructed from UV-stabilized ABS material fabricated in one or more pieces. The enclosure 202 can be mounted via wall mollies using circular holes on the back of a wall plate. Additionally, on the back of the wall plate can be wire channels, 90 degrees from each other, which provide flush mounting options for the unit USB power cable 204. An LCD 206 or like display onboard the enclosure 202 operates to display indicators, graphics, and/or text, indicating at least one of one or more of an indicator of connection health to the remote wireless tank sensor unit shown at 208, battery health of the remote wireless tank sensor unit shown at 210, exterior tank LP fuel level is shown at 212, and outside ambient temperature shown at 214. Other indicia may be displayed depending on system capabilities. The wireless receiver unit 200 may be powered on when the USB Type-A connector wire 204, which exits the back or bottom of the enclosure 202, is inserted into an external wall power supply and the power supply inserted into normal AC line voltage (e.g., 120 v). Likewise, when disconnected the unit is not powered.

With continued reference to FIG. 4, the system MCU may clock at 80 MHZ. The MCU communicates with the 915 MHZ ISM Band FSK transceiver which in turn communicates with the wireless tank sensor unit 100. The WIFI function of the ESP8266 chip provides internet TCP/IP connectivity as well as a web server for user interaction and configuration. A system voltage regulator may step down the battery voltage of 5.0 VDC to 3.3 VDC for the system. The programming port may be a UART serial port. System SPI flash may contain configuration and state-full information. A GPIO extender may work with the MCU to integrate with the onboard 16×2 LCD.

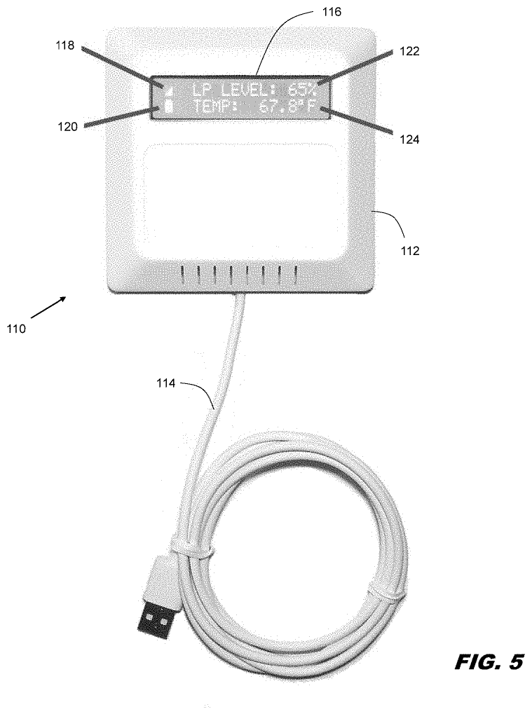

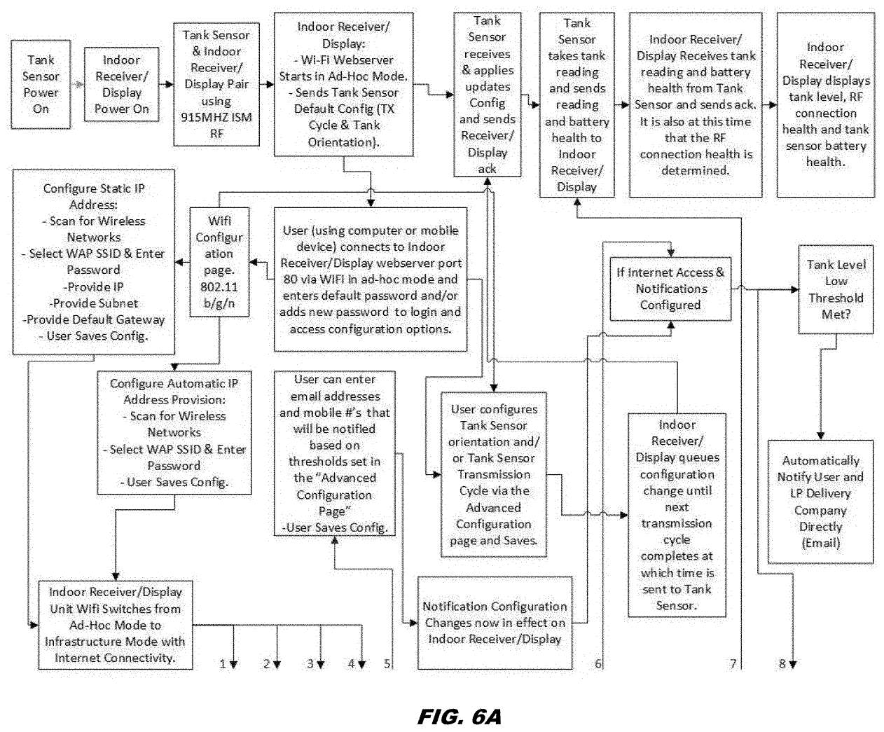

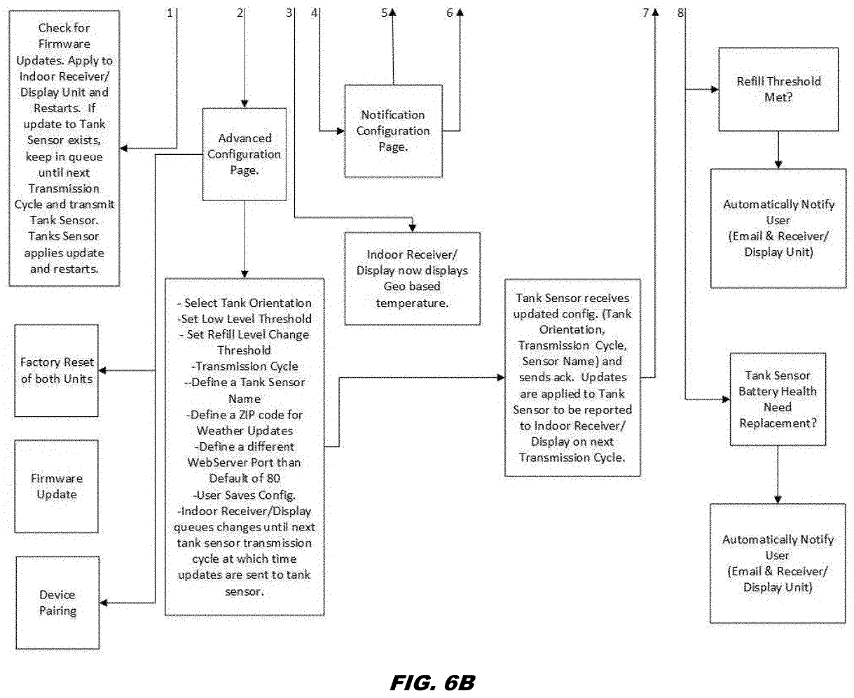

With reference to FIGS. 6A and 6B, in some embodiments, when configured for regular operation, the wireless receiver unit 200 may operate to:

a. listen for scheduled updates from the wireless tank sensor unit 100, receive data via the RF module related to fuel level and battery life, and confirm receipt of data by sending an acknowledgment (ACK) back to the wireless tank sensor unit RF module;

b. process received data, check the data against user-defined notification thresholds, and take action to notify (e.g., if internet access is configured), updated information is stored in the EEPROM;

c. determine, after every received update, the received signal strength indicator (RSSI) (e.g., reception quality of the tank sensor communication RF link); and

d. update and display information (e.g., signal strength, battery life, fuel level expressed as a percentage remaining, ambient air temperature, etc.) on the 16×2 LCD.

In some embodiments, WIFI operating modes may include an internet disconnected mode (e.g., for users who do not have internet access and do not require the unit to be connected to the internet) and an internet-connected mode (e.g., for users who do have internet access and wish to take advantage of extended notification capabilities of the system).

In some embodiments, an integrated WIFI web server may be used for current data and user configuration options. An internet disconnected mode (e.g., P2P or Ad-Hoc Mode) provides the user with the capability to initially configure the unit WIFI to become a node on a WIFI network if they so choose, while also providing connectivity so the user can view fuel level and other vital statistics and configuration data. In some embodiments, full capabilities of the system (e.g., certain notifications and firmware enhancements) may not be realized without a connection to the internet. Internet-connected mode (e.g., infrastructure Mode) is when the user has configured the unit over WIFI to become a node on their private WIFI network which has access to the internet. Providing access to the internet allows the wireless receiver unit to process outgoing notifications via email, and in some embodiments and/or SMS messages, while also providing the capability to receive a geo-based temperature using the WAN address provided by the user's ISP. Internet access also provides the user with access to firmware enhancements as they become available.

Pairing is initiated when both the wireless tank sensor unit 100 and the wireless receive unit 200 are powered on. At the same time, the wireless receiver unit WIFI system starts in P2P/Ad-Hoc web server mode, with a preconfigured static IP address, for initial user configuration. A user connects to the webserver using a mobile device/computer HTTP browser and is presented with a login screen prompting for the user to enter a password. Every device may have assigned a unique hardcoded default system password. The user may be prompted to add a new password during the initial set-up.

After successful password authentication, the user may be presented with WIFI configuration options for internet connectivity. If the user does not want/or have internet connectivity, the user may exit from this screen and remain in P2P/Ad-Hoc Mode. At this point the system may operate using default factory settings (e.g., 15-minute transmission cycle and a horizontal tank configuration) and one option may to set the tank orientation (i.e., vertical or horizontal). When tank orientation is changed the change may be queued within the wireless receiver unit until the next receive event from the wireless tank sensor unit, at which time the configuration change is sent to the wireless tank sensor unit 100 and applied.

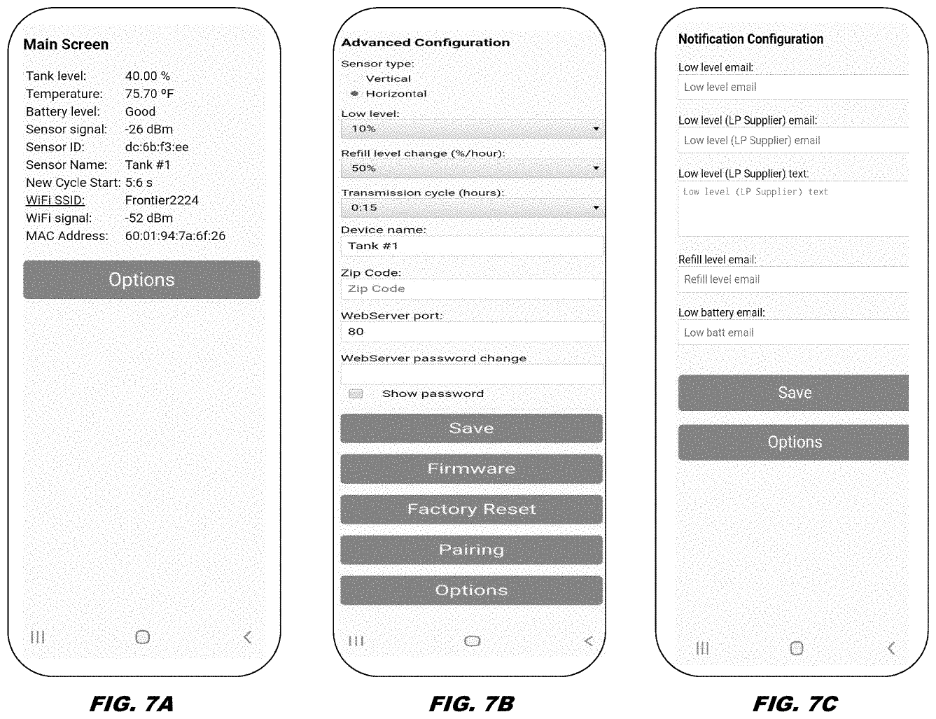

With specific reference to FIG. 7A, a WIFI configuration screen/menu may display available infrastructure WIFI networks, via SSID's, which may be scanned for and selected. Entering and confirming a valid password for the selected WIFI network reboots the wireless receiver unit into infrastructure mode and provides a dynamic IP address from the infrastructure WIFI's DHCP. Technical users have the capability to configure a static IP address and port to the wireless receiver unit. In some embodiments, the system may remain in the P2P/Ad-Hoc mode indefinitely. In this mode, the system may run in basic mode with limited functionality. Basic mode may provide, for example, a fuel level reading only.

With specific reference to FIGS. 7B and 7C, infrastructure modes provide a vast set of notifications and advanced configuration options for the system, as well as geo-based temperature readings. Internet access allows for firmware enhancements as available. Firmware enhancements for the wireless receiver unit may be set for automatic download. Firmware enhancements for the wireless tank sensor unit may also be set for automatic download and may be queued in the wireless receiver unit and sent to the wireless tank sensor unit during the next receive event, at which time the firmware enhancement is sent to the wireless tank sensor unit and applied.

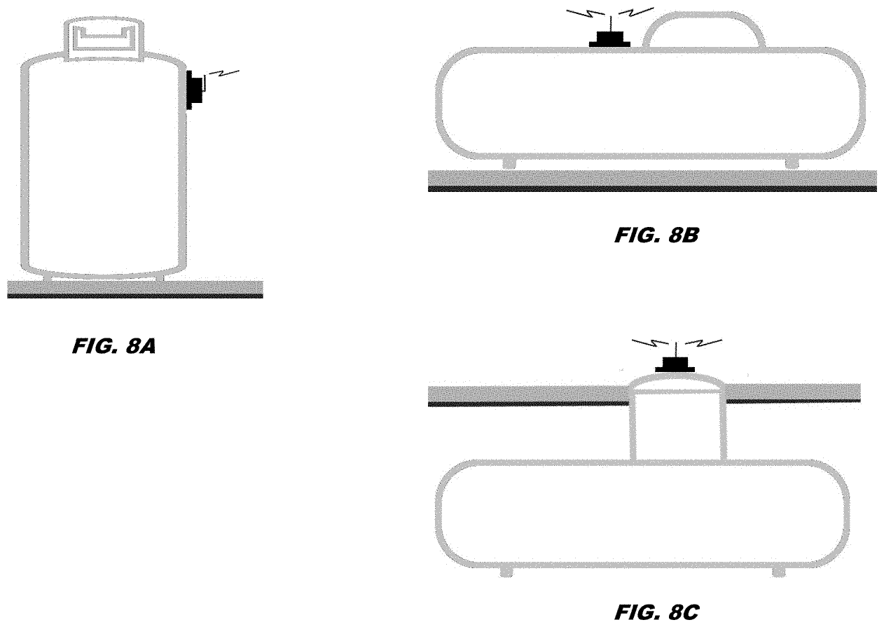

With continued reference to FIGS. 6A and 6B, advanced configuration options may include setting the tank orientation. With reference to FIGS. 8A-8C, configurable tank orientations and locations may include, but are not limited to, vertical and above ground as shown in FIG. 8A, horizontal and above ground as shown in FIG. 8B, and horizontal and below ground as shown in FIG. 8C. Respective wireless tank sensor unit placements include side-mounted and top pointed in which the knuckled antenna permits antenna positioning substantially perpendicular to ground level. Other configuration options include setting a low-level threshold(s) (e.g., dropdown menu with selectable 5% increments) that trigger notifications, and refill level change threshold (e.g., dropdown menu with selectable 5% increments). For example, the user may not choose to consider 80% full (standard LP tanks full threshold) as a refill event, but maybe 50%, or 60%, or something lower than 80%, to accommodate their budget at the time a fuel refill is needed. Transmission cycle can be set (e.g., dropdown menu with selectable times of 15 m, 30 m, 45 m, 1 hr, 4 hr, 6 hr, 8 hr, 12 hr, and 24 hr) corresponding to the frequency of measurements/time between measurements. Changes to the transmission cycle may be queued in the wireless receiver unit until the next receive event from the wireless tank sensor unit at which time the configuration changes are sent and applied to the wireless tank sensor unit. Other configurations may include a device name which may be an optional field where a wireless tank sensor unit may be assigned a customizable name. Zip Code is blank by default and is optional. When this field is blank the wireless receiver unit may be configured to display the temperature based on the customer's ISP WAN Address and therefore will be approximate to the actual device location. Entering a zipcode will yield a more accurate temperature. A webserver port provides the capability to change the default webserver port to something other than port 80. Webserver password change allows for a user to change their personal password set during the initial configuration and first-time login of the system.

Notifications are configurable. For example, an email address may be entered to receive notification(s) when a low-level threshold is exceeded. The email address may be that of a customer and/or a fuel supplier. The same field may also be used to store specific account information to the supplier which may appear in the body of the email received (e.g., account number, street address, etc.). Email may include refill events. Notifications can also include but are not limited to, low battery notifications and system error notifications. For system configurations without internet connectivity, notifications in the form of visual and/or audible notifications may be displayed via the wireless receiver unit 110.

After successful login, a main screen of the app (e.g., see FIG. 7A) may display one or more configurable fields including tank level, air temperature, battery level, sensor signal, sensor ID, sensor unit name, cycle time, time to next cycle, WIFI network, WIFI signal strength, and IP address.

In some embodiments, configuration options include refill level change expressed as a percentage per hour (%/hour). This configuration allows the user to select the maximum percentage of change that can take place in, for example, one hour to be considered a tank refill event and trigger an automatic notification. Considering LP tanks are typically filled to a maximum of 80% of total tank volume, choosing a refill level change percentage of 20% may mean 20% of 80% which equals a 16% change triggering a notification. For example, assuming a tank volume of 35% full when propane is added, a notification event would therefore occur when the tank is filled 16% or more (which equates to an LP tank reading of 50% or more). The foregoing is one example of a configurable refill event.

In some embodiments, another customizable or configurable setting may include transmission cycle, which corresponds to the frequency of tank fuel level updates by the wireless tank sensor unit. For example, a configurable setting may include a fuel level update every 15 min, 30 min, 45 min, 1 hr, 4 hrs . . . 24 hrs, among others. Battery life can be extended by selecting a longer period between transmission events. In some embodiments, the time period between a fuel level data transmission and a next fuel level data transmission and subsequent fuel level data transmission may be be configured or selected according to the user's consumption habits.

In general, the wireless tank sensor unit 100 is configured to monitor, via the liquid level fuel gauge assembly, at least the fuel level in the fuel tank. The fuel level and additional event and status information are transmitted to the wireless receiver unit at the scheduled intervals using ISM transceivers. The wireless receiver unit 200 may utilize WIFI for internet connectivity for notifications and weather information. Communication between the two units may be initiated by the wireless tank sensor unit 100 but can become bi-directional once an ISM transceiver data session has been established. Initial setup and configuration (as well as all subsequent user-initiated configuration changes) take place via HTTP sessions at the wireless receiver unit, which allows the wireless receiver unit to communicate configuration changes to the wireless tank sensor unit.

RF, as used herein, is intended to apply to all forms of wireless transmission regardless of the frequency (e.g., 950 MHZ, 2 GHZ, 5 GHZ, Bluetooth, WIFI, etc.). In preferred embodiments, the system provides a two-tier RF solution in which the first-tier transceiver (915 MHZ) provides communication between the wireless tank sensor unit 100 and the wireless receiver unit 200, and the second-tier (WIFI (2 GHZ) transceiver located in the wireless receiver unit 200 provides the capability to connect to the mobile application and as a bridge to the internet for advanced reporting and notification features.

In comparison to conventional third-party monitored systems, the present system provides user autonomy and privacy in a closed-loop system. Configuration options for the user include, but are not limited to, the manner in which notifications (e.g., alerts) are received, refill level percentage control (e.g., refill to full, refill to 50%, refill to 75%, etc.), transmission cycle time control (e.g., every 15 m, every 24 hrs), ambient temperature reporting without the need for a temperature sensor, factory reset control, software updates, notification configuration, etc. Additional functionality through the mobile application may include the ability to record and track usage statistics. Regarding refill events, the autonomy of the system allows the user to contact a fuel provider of their choice and freely change their choice at will.

Although several embodiments of the invention have been illustrated in the accompanying drawings and described in the foregoing detailed description, it will be understood that the invention is not limited to the embodiments disclosed but is capable of numerous rearrangements, modifications, and substitutions of parts and elements without departing from the spirit of the invention.

What is claimed is:

1. A fuel level monitoring system, comprising:
a wireless tank sensor unit operable for transmitting fuel level data obtained via a coupling with a fuel level gauge assembly installed on the fuel tank, the wireless tank sensor unit including a radio frequency (RF) transmitter and antenna pairing and a power supply;
a wireless receiver unit positionable in a location remote from the wireless tank sensor unit and in RF range thereof, the wireless receiver unit including an RF receiver and antenna pairing, a liquid crystal display (LCD), and a processor coupled to a storage medium having encoded thereon executable instructions that, when executed by the processor, cause the processor to:
receive, via the RF receiver and antenna pairing, fuel level data transmitted by the wireless tank sensor unit via the RF transmitter and antenna pairing, and confirm receipt thereof by sending an acknowledgment back to the wireless tank sensor unit;
cause the LCD to display the received fuel level data as a percentage of fuel remaining;
process the received fuel level data by comparing the received fuel level data against at least one stored user-defined notification threshold and, responsive to the received fuel level data exceeding the at least one stored user-defined notification threshold, causing the LCD to display a notification indicating action to be taken corresponding to a refill event; and
determine, after each transmission of the fuel level data, a received signal strength.

2. The fuel level monitoring system according to claim 1, wherein the wireless tank sensor unit is further operable to transmit battery level data related to the power supply, and wherein the processor is further configured to receive, via the RF receiver and antenna pairing, battery level data transmitted by the wireless tank sensor unit and cause the LCD to display battery level data as a percentage of battery life remaining.

3. The fuel level monitoring system according to claim 1, wherein the at least one user-defined stored notification threshold is a configurable refill level change setting expressed as a fuel level volume percentage change per a predetermined time period, and wherein a monitored fuel level volume percentage change exceeding the configured refill level change setting causes the processor to display the notification.

4. The fuel level monitoring system according to claim 1, wherein a time between a fuel level data transmission and a next fuel level data transmission by the wireless tank sensor unit is a configurable setting.

5. The fuel level monitoring system according to claim 1, further comprising a mobile application installable on a portable electronic device, wherein the wireless receiver unit is configured to communicate to the mobile application, via a wireless internet connection, the fuel level data as the percentage of fuel remaining and the notification indicating the action to be taken corresponding to the refill event.

6. The fuel level monitoring system according to claim 1, wherein at least one stored user-defined notification threshold corresponds to a percentage of fuel remaining.

7. The fuel level monitoring system according to claim 1, wherein the wireless tank sensor unit comprises:
an enclosure containing the RF transmitter and the power supply and to which the antenna is externally attachable;
a wire for coupling with the fuel level gauge assembly; and
a power switch.

8. The fuel level monitoring system according to claim 1, wherein the wireless receiver unit comprises:
a wall-mountable enclosure containing the RF receiver and antenna pairing and supporting the LCD; and
a power supply cable connectable to a power supply.

9. The fuel level monitoring system according to claim 1, wherein the processor is further configured to cause the LCD to display the determined received signal strength.

10. The fuel level monitoring system according to claim 1, wherein the system is operable in an internet-connected mode or an internet disconnected mode.

11. The fuel level monitoring system according to claim 1, wherein the wireless tank sensor unit is operable to transmit the fuel level data according to a configurable time interval.

12. A fuel level monitoring system, comprising:
a wireless tank sensor unit attachable to an exterior fuel tank and operable for transmitting fuel level data, the wireless tank sensor unit including an enclosure containing a radio frequency (RF) transmitter and a power supply, an external antenna, and a wire lead for coupling to a fuel gauge assembly installed on the exterior fuel tank;
a wireless receiver unit positionable in a location remote from the wireless tank sensor unit and in RF range thereof, the wireless receiver unit including a wall-mountable enclosure containing an RF receiver, an antenna, a liquid crystal display (LCD), and a processor coupled to a storage medium having encoded thereon executable instructions that, when executed by the processor, cause the processor to:
receive, via the RF receiver and the antenna, fuel level data transmitted by the wireless tank sensor unit via the RF transmitter;
cause the LCD to display the received fuel level data as a percentage of fuel remaining;
process the received fuel level data by comparing the received fuel level data against at least one stored user-defined notification threshold and, responsive to the received fuel level data exceeding the at least one stored user-defined notification threshold, causing the LCD to display a notification indicating action to be taken corresponding to a refill event; and
determine, after each transmission of the fuel level data, a received signal strength.

13. The fuel level monitoring system according to claim 12, wherein the wireless tank sensor unit is further operable to transmit battery level data related to the power supply, and wherein the processor is further configured to receive, via the RF receiver and antenna, battery level data transmitted by the wireless tank sensor unit and cause the LCD to display battery level data as a percentage of battery life remaining.

14. The fuel level monitoring system according to claim 12, further comprising a mobile application installable on a portable electronic device, wherein the wireless receiver unit is configured to communicate to the mobile application, via a wireless internet connection, the fuel level data as the percentage of fuel remaining and the notification indicating the action to be taken corresponding to the refill event.

15. The fuel level monitoring system according to claim 12, wherein the at least one user-defined stored notification threshold is a configurable refill level change setting expressed as a fuel level volume percentage change per a predetermined time period, and wherein a monitored fuel level volume percentage change exceeding the configured refill level change setting causes the processor to display the notification.

16. The fuel level monitoring system according to claim 12, wherein a time between a fuel level data transmission and a next fuel level data transmission by the wireless tank sensor unit is a configurable setting.

17. The fuel level monitoring system according to claim 12, wherein at least one stored user-defined notification threshold corresponds to a percentage of fuel remaining.

18. The fuel level monitoring system according to claim 12, wherein the processor is further configured to cause the LCD to display the determined received signal strength.

19. The fuel level monitoring system according to claim 12, wherein the system is operable in an internet-connected mode or an internet disconnected mode.

20. The fuel level monitoring system according to claim 12, wherein the wireless tank sensor unit is operable to transmit the fuel level data according to a configurable time interval.
